(19) United States
(12) Patent Application Publication
(10) Pub. No.: US 2025/0017430 A1
(43) Pub. Date: Jan. 16, 2025

(54) SUCTION DEVICE

(71) Applicant: SK On Co., Ltd., Seoul (KR)

(72) Inventors: Bong Kun CHO, Daejeon (KR); Jun Yeon KANG, Daejeon (KR)

(21) Appl. No.: 18/770,662

(22) Filed: Jul. 12, 2024

(30) Foreign Application Priority Data
Jul. 12, 2023 (KR) 10-2023-0090697
Apr. 9, 2024 (KR) 10-2024-0047826

(51) Int. Cl. A47L 9/16

(52) U.S. Cl. CPC A47L 9/1683; A47L 2201/024

(57) ABSTRACT

A suction device of the present disclosure includes: a suction portion suctioning foreign substances from an electrode; a dust collection portion forming a negative pressure; and a manifold connected to each of the suction portion and the dust collection portion and suctioning the foreign substances using the negative pressure of the dust collection portion, wherein the manifold includes a docking portion discharging foreign substances inside the manifold to the outside.

### CROSS-REFERENCE TO RELATED PATENT APPLICATION

The present application claims priority under 35 U.S.C. § 119 (a) to Korean patent application number 10-2023-0090697 filed on Jul. 12, 2023 and Korean patent application number 10-2024-0047826 filed on Apr. 9, 2024, in the Korean Intellectual Property Office, the entire disclosure of which is incorporated by reference herein.

### BACKGROUND OF THE INVENTION

### 1. Field

The present disclosure relates to a secondary battery, and specifically to a suction device suctioning foreign substances from an electrode.

### 2. Description of the Related Art

Secondary batteries may be reused multiple times through charging and discharging. Secondary batteries are widely used across industries due to their economical and eco-friendly characteristics.

A secondary battery include electrodes. A suction device may suction in foreign

substances from an electrode generated during an electrode manufacturing process (e.g., notching process, press process, etc.). In this case, the problem of foreign matters accumulating inside a suction device may occur, and a technology to solve this problem is required.

### SUMMARY OF THE INVENTION

An object of an embodiment of the present disclosure is to provide a suction device preventing accumulation of foreign substances.

The present disclosure can be widely applied in the field of green technology, such solar power generation and wind power generation. In addition, the present disclosure may be used in eco-friendly devices, such as electric vehicles and hybrid vehicles, to prevent climate change by suppressing air pollution and greenhouse gas emissions.

A suction device according to an embodiment of the present disclosure may include: a suction portion suctioning foreign substances from an electrode; a dust collection portion forming a negative pressure; and a manifold connected to each of the suction portion and the dust collection portion and suctioning the foreign substances using the negative pressure of the dust collection portion, wherein the manifold includes a docking portion discharging foreign substances inside the manifold to the outside.

In an embodiment, the docking portion may be connected to a suction hose of an external device.

In an embodiment, a manifold may further include a dust collection connection portion connected to the dust collection portion and a suction connection portion connected to the suction portion, and the dust collection connection portion and the suction connection portion may protrude in opposite directions from a main body of the manifold.

In an embodiment, a dust collection portion may include a filter that blocks foreign substances having a size larger than a preset size.

In an embodiment, among foreign substances, foreign substances having a size larger than a preset size may be discharged to the outside through a suction connection portion and a docking portion.

In an embodiment, among foreign substances, foreign substances having a size smaller than or equal to a preset size may be discharged to a dust collection portion through a suction connection portion and a dust collection connection portion.

In an embodiment, a suction portion may include a first suction portion suctioning foreign substances generated while an electrode is pressed and a second suction portion suctioning foreign substances generated while an electrode is notched, and a manifold may include a first suction connection portion connected to the first suction portion and a second suction connection portion connected to the second suction portion.

In an embodiment, a negative pressure of a dust collection portion may be supplied to a first suction connection portion and a second suction connection portion.

In an embodiment, a first suction connection portion and a second suction connection portion may protrude from a same surface of a main body of a manifold.

In an embodiment, a manifold may further include an inclined portion having an inclination so that foreign substances suctioned into the manifold slide toward a docking portion.

In an embodiment, a docking portion may protrude downward from the main body of the manifold.

In an embodiment, a manifold may further include a window through which the interior of the manifold is viewed.

An embodiments of the present disclosure can provide a suction device that prevents accumulation of foreign substances.

According to an embodiment, foreign substances in a suction device can be easily removed.

According to an embodiment, even when removing (or cleaning) foreign substances, the interruption of operation of a facility can be minimized.

### BRIEF DESCRIPTION OF THE DRAWINGS

FIG. 1 shows a block diagram for explaining a suction device and an electrode manufacturing device according to an embodiment.

FIG. 2 shows a diagram for explaining a manifold according to an embodiment.

FIGS. 3 and 4 show diagrams of a manifold according to an embodiment from different directions.

FIG. 5 shows a diagram for explaining a suction portion according to an embodiment.

FIG. 6 shows a diagram for explaining an electrode manufacturing device according to an embodiment.

### DETAILED DESCRIPTION

The structural or functional descriptions of embodiments disclosed in the present specification or application are merely illustrated for the purpose of explaining embodiments according to the technical principle of the present invention, and embodiments according to the technical principle of the present invention may be implemented in various forms in addition to the embodiments disclosed in the specification of application. In addition, the technical principle of the present invention is not construed as being limited to the embodiments described in the present specification or application.

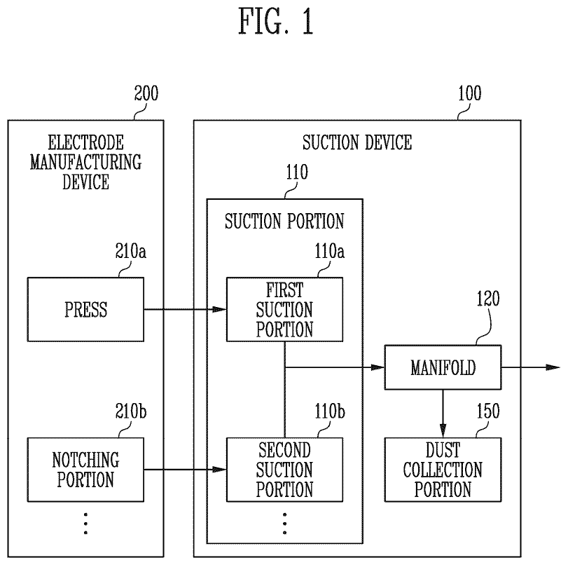

FIG. 1 shows a block diagram for explaining a suction device and an electrode manufacturing device according to an embodiment.

Referring to FIG. 1, a suction device 100 according to an embodiment may suction foreign substances from an electrode. For example, an electrode may be a cathode or an anode of a secondary battery. Foreign substances from an electrode may be foreign substances generated by an electrode manufacturing device 200. In an embodiment, an electrode manufacturing device 200 may include a press 210a and a notching portion 210b for manufacturing an electrode.

In an embodiment, a suction device 100 may include a suction portion 110, a dust collection portion 150, and a manifold 120.

A suction portion 110 may suction foreign substances from an electrode. Foreign substances in an electrode may be foreign substances generated during a process in which an electrode manufacturing device 200 manufactures an electrode. In an embodiment, foreign substances from an electrode may include at least one of foreign substances generated by a press 210a and foreign substances generated by a notching portion 210b. For example, foreign substances may be debris or dust or others separated from an electrode during a process of pressing or notching the electrode. A suction portion 110 may be coupled with an electrode manufacturing device 200 or may be disposed separately from an electrode manufacturing device 200.

A dust collection portion 150 may generate a negative pressure. Specifically, a dust collection portion 150 may generate a negative pressure to suction or collect foreign substances. Here, a negative pressure may mean a pressure lower than a reference pressure or vacuum. For example, a reference pressure may be atmospheric pressure or 1 atm, but may be modified to various values. In an embodiment, a dust collection portion 150 may form a pressure difference between an inlet and an outlet. For example, a dust collection portion 150 may include at least one of a pump, compressor, and motor. A dust collection portion 150 may remove at least a portion of air from a closed or sealed internal space, thereby lowering the pressure and generating a negative pressure. A dust collection portion 150 may supply a negative pressure to a suction portion 110 through a manifold 120. In other words, a dust collection portion 150 may transmit a suction force to a suction portion 110 through a manifold 120. A dust collection portion 150 may suction foreign substances from an electrode through a suction portion 110 and a manifold 120.

In an embodiment, a suction portion 110 may be positioned inside an electrode manufacturing device 200, and a dust collection portion 150 may be positioned outside the electrode manufacturing device 200, but are not limited thereto.

A manifold 120 may be connected to each of a suction portion 110 and a dust collection portion 150. A manifold 120 may suction foreign substances using a negative pressure of a dust collection portion 150. For example, a negative pressure generated in a dust collection portion 150 may generate an internal air current flowing in the order of a suction portion 110, a manifold 120, and a dust collection portion 150. Foreign substances from an electrode may move along an internal air current. In this case, a manifold 120 may suction foreign substances from the electrode suctioned into a suction portion 110.

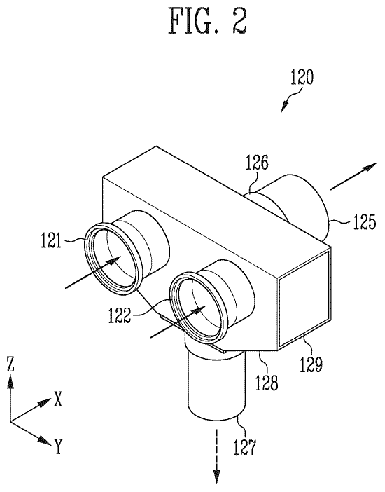

A manifold 120 may include a docking portion 127 (see FIG. 2). A docking portion 127 may discharge foreign substances inside a manifold 120 to the outside. A docking portion 127 may discharge foreign substances through a different path from a dust collection portion 150.

In an embodiment, a docking portion 127 may be connected to a suction hose of an external device. An external device may suction foreign substances inside a manifold 120 through a docking portion 127 connected to a suction hose and the suction hose. In other words, a manifold 120 may discharge internal foreign substances to the outside through a docking portion 127. For example, an external device may be a cleaning device outside a suction device 100. A cleaning device may include a suction hose and a dust collection portion connected to the suction hose.

The number of suction portions 110 may be one or a plural number. In an embodiment, a suction portion 110 may include a first suction portion 110a and a second suction portion 110b. A first suction portion 110a may suction foreign substances generated while an electrode is pressed. For example, a first suction portion 110a may suction foreign substances generated by a press 210a. A second suction portion 110b may suction foreign substances generated while an electrode is notched. For example, a second suction portion 110b may suction foreign substances generated by a notching portion 210b. In one embodiment, a suction portion 110 may further include an additional suction portion. A manifold 120 may be connected to each of a first suction portion 110a and a second suction portion 110b. In an embodiment, a negative pressure of a dust collection portion 150 may be supplied to each of a first suction portion 110a and a second suction portion 110b through a manifold 120. A manifold 120 may distribute a negative pressure to a first suction portion 110a and a second suction portion 110b.

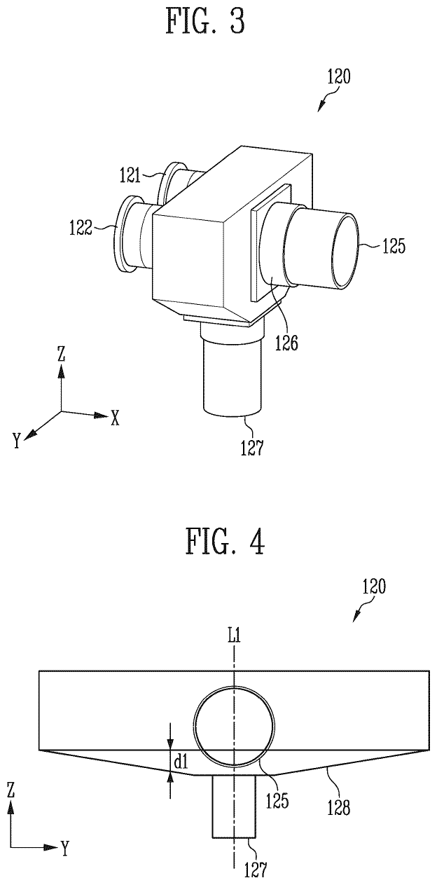

FIG. 2 shows a diagram for explaining a manifold according to an embodiment. FIGS. 3 and 4 show diagrams of a manifold according to an embodiment from different directions.

Referring to FIGS. 2 to 4, a manifold 120 according to an embodiment may include

a docking portion 127. A docking portion 127 may be connected to a suction hose of an external device. A docking portion 127 may have the shape of a pipe. In an embodiment, a docking portion 127 may have protrusions, grooves, or threads formed on an outer surface thereof to facilitate coupling to a suction hose of an external device. A docking portion 127 may allow the interior of a manifold 120 to be cleaned while a facility is in operation without stopping the operation of the facility.

In an embodiment, a docking portion 127 may be opened to be connected to the outside or closed to block connection to the outside. For example, a docking portion 127 may be opened and closed by a detachable cover. For another example, a docking portion 127 may include a door or valve that may be opened and closed.

In an embodiment, a manifold 120 may further include a dust collection connection portion 125 and a suction connection portion 121 and 122. A dust collection connection portion 125 may be connected to a dust collection portion 150. A suction connection portion 121 and 122 may be connected to a suction portion 110. For example, each of a dust collection connection portion 125 and a suction connection portion 121 and 122 may have the shape of a pipe. Here, the dust collection connection portion 125 and the suction connection portion 121 and 122 may protrude in opposite directions from a main body of a manifold 120. In this case, since the flow of an internal air current may be maintained, a decrease in dust collection performance may be prevented. For example, a dust collection connection portion 125 may protrude in a first horizontal direction (e.g., +X-axis direction) and a suction connection portion 121 and 122 may protrude in a direction opposite to the first horizontal direction (e.g., −X-axis direction). In an embodiment, a dust collection connection portion 125 and a suction connection portions 121 and 122 may be formed on opposite surfaces of a main body of a manifold 120.

In an embodiment, a manifold 120 may supply a negative pressure supplied from a dust collection connection portion 125 to a suction connection portion 121 and 122. In this case, a flow of an internal air current may be generated due to the negative pressure, and according to the flow of the internal air current, the manifold 120 may suction foreign substances from an electrode in a suction portion 110 through the suction connection portion 121 and 122.

In an embodiment, the number of suction connection portions 121 and 122 may be one or a plural number. Referring to FIGS. 1 and 2, in an embodiment, the suction connection portion 121 and 122 may include a first suction connection portion 121 and a second suction connection portion 122. Here, the first suction connection portion 121 may be connected to a first suction portion 110a, and the second suction connection portion 122 may be connected to a second suction portion 110b. In an embodiment, a suction connection portion 121 and 122 may further include an additional suction connection portion. In an embodiment, a negative pressure of a dust collection portion 150 may be supplied to each of a first suction connection portion 121 and a second suction connection portion 122. When a negative pressure is supplied from a dust collection connection portion 125, a first suction connection portion 121 may suction foreign substances generated by a press 210a through a first suction portion 110a. When a negative pressure is supplied from a dust collection connection portion 125, a second suction connection portion 122 may suction foreign substances generated by a notching portion 210b through a second suction portion 110b.

In an embodiment, a first suction connection portion 121 and a second suction connection portion 122 may protrude from a same surface of a main body of a manifold 120. For example, as shown in FIGS. 2 and 3, a first suction connection portion 121 and a second suction connection portion 122 may protrude from a surface of a main body in the-X axis direction.

In an embodiment, a dust collection portion 150 may include a filter 126. A filter 126 may block foreign substances having a size larger than a preset size. A filter 126 may allow foreign substances having a size smaller than or equal to a preset size to pass. Here, the size may be volume or diameter. For example, a filter 126 may be a mesh-structured filter. A filter 126 may be disposed at a boundary between a manifold 120 and a dust collection portion 150. A filter 126 may minimize clogging of a dust collection portion 150 or decrease of dust collection performance due to large-sized foreign substances.

In an embodiment, foreign substances inside a manifold 120 having a size larger than or equal to a preset size may be discharged to the outside through a suction connection portion 121 and 122 and a docking portion 127. For example, foreign substances having a size larger than a preset size may be blocked from moving from a manifold 120 to a dust collection portion 150 by a filter 126. In this case, foreign substances having a size larger than a preset size may be discharged to the outside through a docking portion 127.

In an embodiment, foreign substances inside a manifold 120 having a size smaller than or equal to a preset size may be discharged to a dust collection portion 150 through a suction connection portion 121 and 122 and a dust collection connection portion 125. For example, foreign substances having a size smaller than or equal to a preset size may pass through a filter 126 in a manifold 120 and be moved to a dust collection portion 150. A dust collection portion 150 may collect small-sized dust that has passed through a filter 126.

In an embodiment, a manifold 120 may further include an inclined portion 128. An inclined portion 128 may have an inclination so that foreign substances suctioned into a manifold 120 may slide toward a docking portion 127. For example, referring to FIG. 4, an inclined portion 128 may include at least a part having an inclination. A part having an inclination may be a section in which the height d1 of an inclined portion 128 increases toward a central axis L1 of a docking portion 127 along a second horizontal direction (e.g., Y-axis direction). In other words, an inclined portion 128 may include a section in which the height d1 of an inclined portion 128 increases as the distance toward a docking portion 127 becomes closer. Large-sized foreign substances may be induced to move toward a docking portion 127 by the section.

In an embodiment, a docking portion 127 may protrude downward from a main body of a manifold 120. A downward direction may be the −Z-axis direction among the height directions. For example, a downward direction may be the direction of gravity.

In an embodiment, a manifold 120 may further include a window 129 through which the interior of the manifold 120 is viewed. For example, a window 129 may include a transparent material such as glass or plastic. A window 129 may be disposed on one surface of a main body of a manifold 120. Through a window 129, the degree of filling of foreign substances or the state of accumulation of foreign substances inside a manifold 120 may be checked. In an embodiment, a window 129 may be implemented in a closed form or in a form that may be opened and closed.

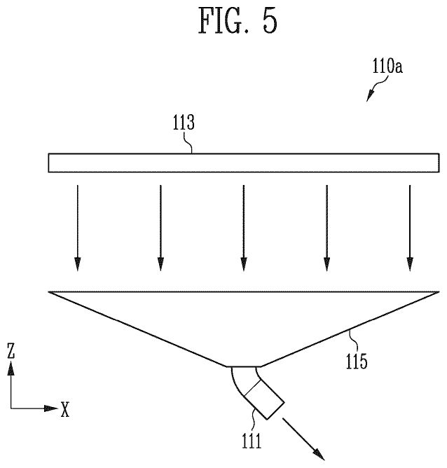

FIG. 5 shows a diagram for explaining a suction portion according to an embodiment.

Referring to FIGS. 1 and 5, a suction portion 110 and a manifold 120 according to an embodiment may be connected to each other. The number of suction portions 110 may be at least one. Hereinafter, a first suction portion 110a will be described as a representative of suction portions 110.

According to an embodiment, a first suction portion 110a may include an upper blowing portion 113, a lower collecting portion 115, and an outlet 111. An electrode may be moved between an upper blowing portion 113 and a lower collecting portion 115. For example, a transfer device equipped with an electrode may be moved between an upper blowing portion 113 and a lower collecting portion 115.

An upper blowing portion 113 may spray air in a downward direction (e.g., −Z-axis direction). In this case, foreign substances may be separated from an electrode by the sprayed air and collected in a lower collection portion 115. Referring to FIGS. 2 and 5, an outlet 111 of a first suction portion 110a may be connected to a first suction connection portion 121 of a manifold 120. An outlet 111 may have the shape of a pipe. An outlet 111 may discharge foreign substances collected in a lower collection portion 115 to a manifold 120 by a negative pressure supplied from the manifold 120 or air sprayed from an upper blowing portion 113.

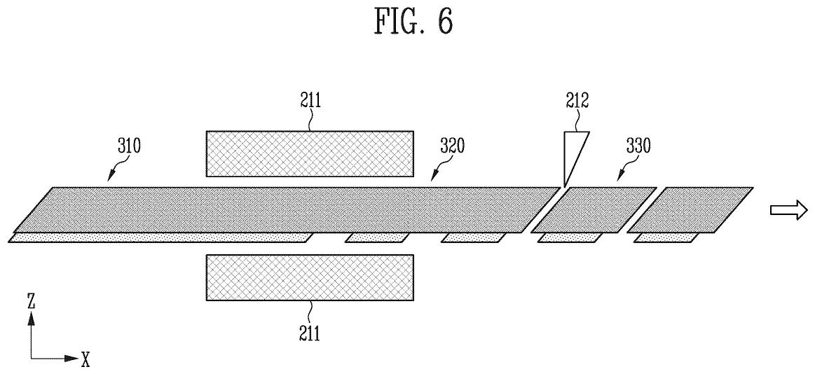

FIG. 6 shows a diagram for explaining an electrode manufacturing device according to an embodiment.

Referring to FIGS. 1 and 6, an electrode manufacturing apparatus 200 according to an embodiment may include a press 210a and a notching portion 210b.

A press 210a may include a top-bottom mold 211. A top-bottom mold 211 may be disposed at the top and bottom of a first electrode 310. A top-bottom mold 211 may process a first electrode 310 into the shape of a second electrode 320 by pressing the first electrode 310 in a vertical direction. A first electrode 310 may include an electrode plate, an active material applied to a surface of the electrode plate, and an electrode tab attached to a side of the electrode plate. A second electrode 320 may in a state of a plurality of fragments processed from a first electrode 310. Foreign substances may be generated when an electrode is processed by a press 210a.

A notching portion 210b may be processed into the form of a third electrode 330 by cutting a second electrode 320 using notching 212. A third electrode 330 may be in a state of sheets processed from a second electrode 320. Notching 212 may be performed by various methods such as laser notching and blade notching.

According to an embodiment of the present disclosure as described above, a suction device 100 preventing accumulation of foreign substances can be provided. According to an embodiment, foreign substances in a suction device 100 can be easily removed. According to an embodiment, even when removing (or cleaning) foreign substances, interruption of operation of a suction device 100 or an electrode manufacturing device 200 can be minimized.

What is claimed is:

1. A suction device, comprising:
a suction portion suctioning foreign substances from an electrode;
a dust collection portion forming a negative pressure; and
a manifold connected to each of the suction portion and the dust collection portion and suctioning the foreign substances using the negative pressure of the dust collection portion,
wherein the manifold includes a docking portion discharging foreign substances inside the manifold to the outside.

2. The suction device according to claim 1, wherein the docking portion is connected to a suction hose of an external device.

3. The suction device according to claim 1, wherein the manifold further includes a dust collection connection portion connected to the dust collection portion and a suction connection portion connected to the suction portion, and
the dust collection connection portion and the suction connection portion protrude in opposite directions from a main body of the manifold.

4. The suction device according to claim 3, wherein the dust collection portion includes a filter that blocks foreign substances having a size larger than a preset size.

5. The suction device according to claim 4, wherein among the foreign substances, foreign substances having a size larger than the preset size are discharged to the outside through the suction connection portion and the docking portion.

6. The suction device according to claim 4, wherein among the foreign substances, foreign substances having a size smaller than or equal to the preset size are discharged to the dust collection portion through the suction connection portion and the dust collection connection portion.

7. The suction device according to claim 1, wherein the suction portion includes a first suction portion suctioning foreign substances generated while the electrode is pressed and a second suction portion suctioning foreign substances generated while the electrode is notched, and
the manifold includes a first suction connection portion connected to the first suction portion and a second suction connection portion connected to the second suction portion.

8. The suction device according to claim 7, wherein the negative pressure of the dust collection portion is supplied to the first suction connection portion and the second suction connection portion.

9. The suction device according to claim 7, wherein the first suction connection portion and the second suction connection portion protrude from a same surface of the main body of the manifold.

10. The suction device according to claim 1, wherein the manifold further includes an inclined portion having an inclination so that foreign substances suctioned into the manifold slide toward the docking portion.

11. The suction device according to claim 10, wherein the docking portion protrudes downward from the main body of the manifold.

12. The suction device according to claim 1, wherein the manifold further includes a window through which the interior of the manifold is viewed.
